(19) United States
(12) Patent Application Publication
(10) Pub. No.: US 2024/0353649 A1
(43) Pub. Date: Oct. 24, 2024

(54) IMAGING LENS SYSTEM HAVING RETAINING ELEMENT AND ELECTRONIC DEVICE

(71) Applicant: LARGAN PRECISION CO., LTD., Taichung City (TW)

(72) Inventors: Chun-Tang TSAI, Taichung City (TW); Lin An CHANG, Taichung City (TW); Ming-Ta CHOU, Taichung City (TW); Ming-Shun CHANG, Taichung City (TW)

(73) Assignee: LARGAN PRECISION CO., LTD., Taichung City (TW)

(21) Appl. No.: 18/762,332

(22) Filed: Jul. 2, 2024

Related U.S. Application Data
(62) Division of application No. 17/183,621, filed on Feb. 24, 2021.

(30) Foreign Application Priority Data
Dec. 11, 2020 (TW) 109143920

(51) Int. Cl. G02B 7/02; G02B 13/18

(52) U.S. Cl. CPC G02B 7/021; G02B 7/026; G02B 13/18

(57) ABSTRACT

An imaging lens system includes an imaging lens assembly, a spacer element and a retaining element. The spacer element is configured to maintain a distance between a first lens element and a second lens element of the imaging lens assembly. The spacer element includes a connecting part connected to the second lens element and a supporting part connected to the connecting part and extending from the connecting part towards an optical axis of the imaging lens assembly. The first lens element is disposed on the supporting part. The retaining element is configured to fix the first lens element to the supporting part. The retaining element includes a retaining surface, and the retaining surface and the first lens element are abutted against each other. There is an air gap between the retaining element and the first lens element, and the air gap is adjacent to the retaining surface.

### RELATED APPLICATIONS

This application is a divisional patent application of U.S. application Ser. No. 17/183,621, filed on Feb. 24, 2021, which claims priority to Taiwan Application 109143920, filed on Dec. 11, 2020, which is incorporated by reference herein in its entirety.

### BACKGROUND

### Technical Field

The present disclosure relates to an imaging lens system and an electronic device, more particularly to an imaging lens system applicable to an electronic device.

### Description of Related Art

With the development of semiconductor manufacturing technology, the performance of image sensors has been improved, and the pixel size thereof has been scaled down. Therefore, featuring high image quality becomes one of the indispensable features of an optical system nowadays. Furthermore, due to the rapid changes in technology, electronic devices equipped with optical systems are trending towards multi-functionality for various applications, and therefore the functionality requirements for the optical systems have been increasing.

Portable electronic devices, such as smart electronic devices and panels, are rapidly developing in recent years, and they are indispensable to our daily lives nowadays. As such, lens modules installed in the portable electronic devices are also rapidly developing. However, with the progress of technology, the quality demands of lens modules are increasing, and thus, in addition to the optical design quality of lens modules, the assembling precision in manufacture of lens modules also needs to be improved. There is one drawback of conventional methods for attaching lens elements using adhesives. Conventionally, adhesives are usually filled in small gaps between lens elements and lens barrel, and the adhesives are usually thick fluids, so it takes a long time for the adhesives to be filled in the gaps. After the adhesives are filled in the gaps, it takes a period of time to cure the adhesives via a curing device, so the total production time would be long, thereby having low production efficiency. Another drawback is that the adhesives deteriorate over time, and the viscidity thereof reduces. As such, the optical axis of lens elements would no longer align with that of the lens barrel, and therefore the service life of the lens modules is shortened. Moreover, there is still another drawback that the mechanical strength of the lens modules is not satisfactory due to the usage of adhesives for attaching lens elements.

Accordingly, how to improve the lens modules so as to meet requirements of firmly fixing the lens elements in the lens barrel, high manufacturing efficiency, increasing mechanical strength of the lens modules, and alleviating deteriorations of the lens modules due to misaligns of optical axes after a long time usage.

### SUMMARY

According to one aspect of the present disclosure, an imaging lens system includes an imaging lens assembly, a spacer element and a retaining element. The imaging lens assembly includes a first lens element and a second lens element. The spacer element is configured to maintain a distance between the first lens element and the second lens element, and the spacer element includes a connecting part and a supporting part. The connecting part and the second lens element are connected to each other. The supporting part is connected to the connecting part and extends from the connecting part towards an optical axis of the imaging lens assembly, and the first lens element is disposed on the supporting part. The retaining element includes a retaining surface, and retaining surface and the first lens element are abutted against each other so as to fix the first lens element to the supporting part of the spacer element. There is an air gap between the retaining element and the first lens element, and the air gap is adjacent to the retaining surface. When an outer diameter of the first lens element is D1, and an outer diameter of the second lens element is D2, the following condition is satisfied: D1/D2<1.

According to another aspect of the present disclosure, an imaging lens system includes an imaging lens assembly, a spacer element and a retaining element. The imaging lens assembly includes a first lens element and a second lens element. The spacer element is configured to maintain a distance between the first lens element and the second lens element, and the spacer element includes a connecting part and a supporting part. The connecting part and the second lens element are connected to each other. The supporting part is connected to the connecting part and extends from the connecting part towards an optical axis of the imaging lens assembly, and the first lens element is disposed on the supporting part. The retaining element includes a retaining surface, and the retaining surface and the first lens element are abutted against each other so as to fix the first lens element to the supporting part of the spacer element. The retaining element is disposed between the first lens element and the second lens element, and the retaining element is not in physical contact with the second lens element. When an outer diameter of the first lens element is D1, and an outer diameter of the second lens element is D2, the following condition is satisfied: D1/D2<1.

According to another aspect of the present disclosure, an imaging lens system includes an imaging lens assembly, a spacer element and a retaining element. The imaging lens assembly includes a first lens element, a second lens element and a third lens element. The spacer element is configured for positioning the first lens element between the second lens element and the third lens element, and the spacer element is configured to maintain a distance between the first lens element and the second lens element and maintain another distance between the first lens element and the third lens element. The spacer element includes a connecting part and a supporting part. The connecting part and the second lens element are connected to each other, and the connecting part and the third lens element are connected to each other. The supporting part is connected to the connecting part and extends from the connecting part towards an optical axis of the imaging lens assembly, and the first lens element is disposed on the supporting part. The retaining element includes a retaining surface, and the retaining surface and the first lens element are abutted against each other so as to fix the first lens element to the supporting part of the spacer element. When an outer diameter of the first lens element is D1, an outer diameter of the second lens element is D2, and an outer diameter of the third lens element is D3, the following conditions are satisfied: D1/D2<1; and D1/D3<1.

According to another aspect of the present disclosure, an electronic device includes one of the aforementioned imaging lens systems and an image sensor, and the image sensor is disposed on an image surface of the imaging lens system.

### BRIEF DESCRIPTION OF THE DRAWINGS

The disclosure can be better understood by reading the following detailed description of the embodiments, with reference made to the accompanying drawings as follows:

FIG. 1 is a perspective view of an imaging lens system according to the 1st embodiment of the present disclosure;

FIG. 2 is a partially sectioned view of the imaging lens system in FIG. 1;

FIG. 3 is a partially sectioned view of some components of the imaging lens system in FIG. 1;

FIG. 4 is an enlarged view of region A in FIG. 3;

FIG. 5 is an exploded view of some components of the imaging lens system in FIG. 1;

FIG. 6 is another exploded view of the some components of the imaging lens system in FIG. 1;

FIG. 7 is a cross-sectional view of the imaging lens system in FIG. 1;

FIG. 8 is an enlarged view of region B in FIG. 7;

FIG. 9 is a perspective view of an imaging lens system according to the 2nd embodiment of the present disclosure;

FIG. 10 is a partially sectioned view of the imaging lens system in FIG. 9;

FIG. 11 is an exploded view of some components of the imaging lens system in FIG. 9;

FIG. 12 is another exploded view of the some components of the imaging lens system in FIG. 9;

FIG. 13 is an enlarged view of region C in FIG. 12;

FIG. 14 is a cross-sectional view of the imaging lens system in FIG. 9;

FIG. 15 is an enlarged view of region D in FIG. 14;

FIG. 16 is a cross-sectional view of an imaging lens system according to the 3rd embodiment of the present disclosure;

FIG. 17 is an enlarged view of region E in FIG. 16;

FIG. 18 is a perspective view of a retaining element in FIG. 16;

FIG. 19 is a perspective view of an imaging lens system according to the 4th embodiment of the present disclosure;

FIG. 20 is a partially sectioned view of the imaging lens system in FIG. 19;

FIG. 21 is an exploded view of some components of the imaging lens system in FIG. 19;

FIG. 22 is an enlarged view of region F in FIG. 21;

FIG. 23 is another exploded view of the some components of the imaging lens system in FIG. 19;

FIG. 24 is a cross-sectional view of the imaging lens system in FIG. 19;

FIG. 25 is an enlarged view of region G in FIG. 24;

FIG. 26 is a perspective view of an image capturing unit according to the 5th embodiment of the present disclosure;

FIG. 27 is a perspective view of another image capturing unit according to one embodiment of the present disclosure;

FIG. 28 is a perspective view of another image capturing unit according to one embodiment of the present disclosure;

FIG. 29 is one perspective view of an electronic device according to the 6th embodiment of the present disclosure;

FIG. 30 is another perspective view of the electronic device in FIG. 29;

FIG. 31 is a block diagram of the electronic device in FIG. 29; and

FIG. 32 is a perspective view of another electronic device according to one embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The present disclosure provides an imaging lens system, and the imaging lens system includes an imaging lens assembly, a spacer element and a retaining element. The imaging lens assembly includes a first lens element and a second lens element. The first lens element can be a glass lens element, and the second lens element can be a plastic lens element.

The spacer element is configured to maintain a distance between the first lens element and the second lens element. The spacer element includes a connecting part and a supporting part. The connecting part and the second lens element are connected to each other. The supporting part is connected to the connecting part and extends from the connecting part towards an optical axis of the imaging lens assembly. The first lens element is disposed on the supporting part. In addition, the second lens element is connected to the spacer element, for example, in an abutting manner. The spacer element can serve as a lens barrel and a spacer, but the present disclosure is not limited thereto.

The retaining element includes a retaining surface. The retaining surface and the first lens element are abutted against each other so as to fix the first lens element to the supporting part of the spacer element. According to the present disclosure, the imaging lens system can include one or more than one retaining elements according to various assembling requirements, and the present disclosure is not limited to the number of retaining elements.

When an outer diameter of the first lens element is D1, and an outer diameter of the second lens element is D2, the following condition is satisfied: D1/D2<1. Therefore, a glass lens element having a relatively small size is favorable for reducing the influence of environmental temperature change on the optical quality.

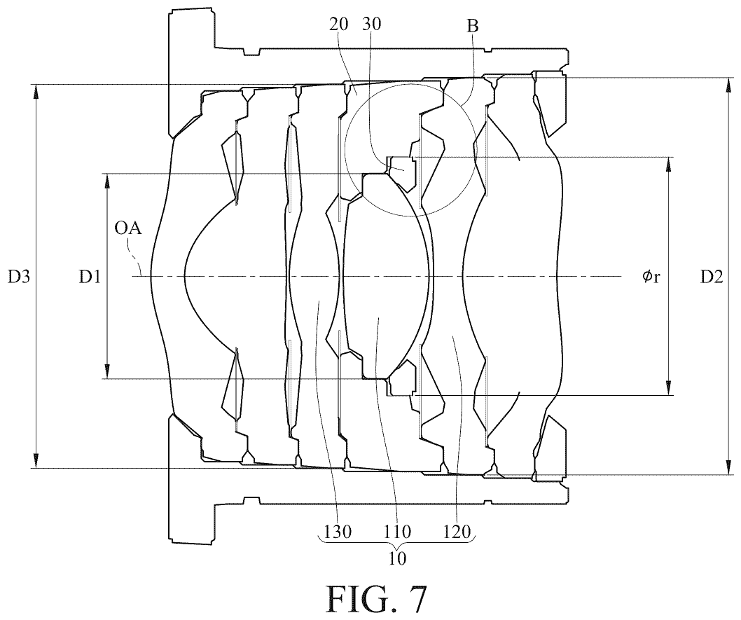

Please refer to FIG. 7, which show a schematic view of D1 and D2 according to the 1st embodiment of the present disclosure.

According to the present disclosure, a configuration of the imaging lens system including a retaining element is helpful for fixing the glass lens element in the imaging lens system more firmly, and it is favorable for preventing misaligned assembling and preventing collisions between components during assembling; furthermore, it is favorable for the glass lens element to be more flexible in optical design so as to obtain optical specifications of higher quality.

There can be an air gap between the retaining element and the first lens element, and the air gap is adjacent to the retaining surface. Therefore, the air gap design is favorable for keeping a higher optical surface quality of the glass lens element and reducing inner surface reflection of lens elements.

The retaining element can be disposed between the first lens element and the second lens element, and the retaining element can be not in physical contact with the second lens element. Therefore, it is favorable for ensuring that the other lens elements are assembled after the glass lens element is firmly fastened, thereby simplifying the assembling process and preventing mechanical interferences.

The imaging lens assembly can further include a third lens element, and the third lens element can be a plastic lens element. In addition, the spacer element can be configured for positioning the first lens element between the second lens element and the third lens element, and configured to maintain the distance between the first lens element and the second lens element and maintain a distance between the first lens element and the third lens element. Therefore, the glass lens element arranged between two plastic lens elements is favorable for reducing the influence of temperature effect (e.g., environmental temperature change) on the optical quality. Moreover, the connecting part of the spacer element and the second lens element can be connected to each other, and the connecting part of the spacer element and the third lens element can be connected to each other. In addition, the second lens element and the third lens element are, for example, respectively connected to different sides of the spacer element in an abutting manner.

When the outer diameter of the first lens element is D1, and an outer diameter of the third lens element is D3, the following condition can be satisfied: D1/D3<1. Therefore, it is favorable for the micro glass lens element to be disposed between the plastic lens elements so as to reduce the influence of environmental temperature change on the optical quality. Please refer to FIG. 7, which show a schematic view of D1 and D3 according to the 1st embodiment of the present disclosure.

The retaining element can be not in physical contact with the second lens element and the third lens element. Therefore, it is favorable for ensuring that the other lens elements are assembled after the glass lens element is firmly fastened, thereby simplifying the assembling process and preventing mechanical interferences.

The retaining surface can be a spherical surface or a circular conical surface (truncated conical surface), and the retaining surface can be in physical contact with a curved surface of the first lens element. Therefore, the configuration of the retaining element with the surface of the glass lens element is favorable for obtaining an effective and secure assembling method. Moreover, the retaining surface and the first lens element can be abutted against each other in a surface contact manner or in a linear contact manner. For example, when the curved surface of the first lens element is a spherical surface, and the retaining surface of the retaining element is a circular conical surface, the curved surface of the first lens element can correspond to the retaining surface of the retaining element and can be in circular linear contact with the retaining surface; when the curved surface of the first lens element is a spherical surface, and the retaining surface of the retaining element is a spherical surface, the curved surface of the first lens element can correspond to the retaining surface of the retaining element and can be in circular surface contact with the retaining surface; the curved surface of the first lens element can extend outwards from the optically effective surface area of the first lens element.

The retaining element can include a plurality of wedged structures, each of the wedged structures tapers off towards the air gap, and the wedged structures are arranged around the optical axis. Therefore, it is favorable for effectively preventing stray light.

There can be a plurality of strip structures disposed between the spacer element and the retaining element, each of the strip structures extends in a direction parallel to the optical axis, and the strip structures are arranged around the optical axis. Therefore, it is favorable for increasing the mechanical strength of the retaining element so as to prevent components from falling off. Moreover, the strip structures can be disposed on the spacer element or the retaining element, and the present disclosure is not limited thereto.

The connecting part of the spacer element can have an axial connection structure, and the axial connection structure is connected to the second lens element. In addition, the axial connection structure includes an annular inclined surface and an annular planar surface, the annular inclined surface is configured to coaxially align the first lens element with the second lens element, and the annular planar surface is configured to maintain the distance between the first lens element and the second lens element. Therefore, the spacer element can indirectly maintain the coaxiality between lens elements via the axial connection structure of the connecting part; furthermore, the axial connection structure can prevent the lens elements from tilting.

The imaging lens assembly can further include an optical shutter disposed between the first lens element and the second lens element, and the optical shutter can be closer to the optical axis than the axial connection structure to the optical axis. Therefore, it is favorable for more effectively sheltering stray light possibly coming from the axial connection structure.

When an outer diameter of the retaining element is Φr, and the outer diameter of the second lens element is D2, the following condition can be satisfied: Φr/D2<1. Therefore, it is favorable for providing assembling feasibility of micro lens elements. Please refer to FIG. 7, which show a schematic view of Φr and D2 according to the 1st embodiment of the present disclosure.

The spacer element can be one-piece formed by injection molding process, and the spacer element has at least two gate traces. Therefore, it is favorable for providing a spacer element having a more complex structure and being more precise in size.

When the number of lens elements of the imaging lens assembly is N, the following condition can be satisfied: 3≤N≤0. Therefore, it is favorable for providing the imaging lens system with high resolving power.

The first lens element can have positive refractive power. Therefore, it is favorable for keeping the back focal length within a smaller manufacturing tolerance so as to increase product quality and yield rate in mass production.

The present disclosure provides an electronic device which includes the aforementioned imaging lens system and an image sensor. The image sensor is disposed on an image surface of the imaging lens system. Moreover, the imaging lens system of the present disclosure is applicable to virtual reality or augmented reality applications, but the present disclosure is not limited thereto.

According to the present disclosure, the aforementioned features and conditions can be utilized in numerous combinations so as to achieve corresponding effects.

According to the above description of the present disclosure, the following specific embodiments are provided for further explanation.

### 1st Embodiment

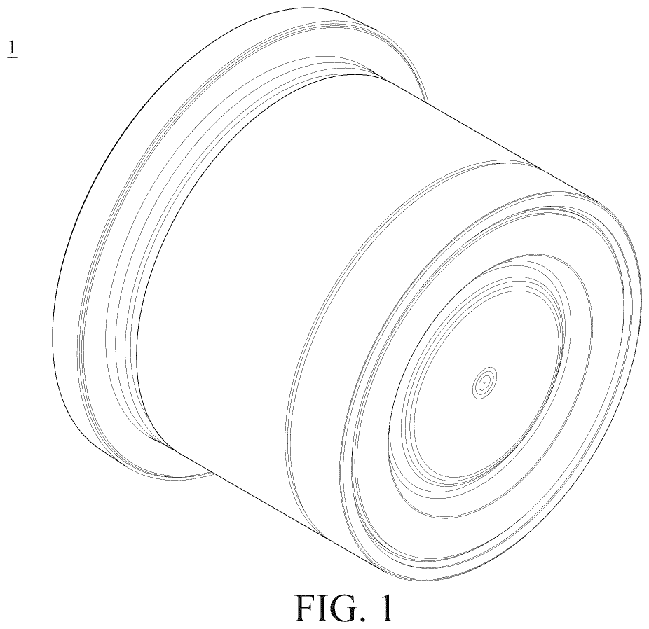

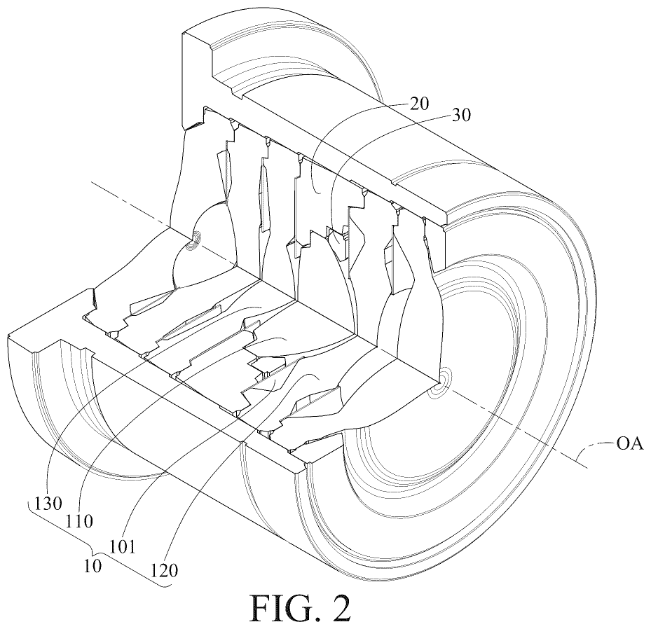

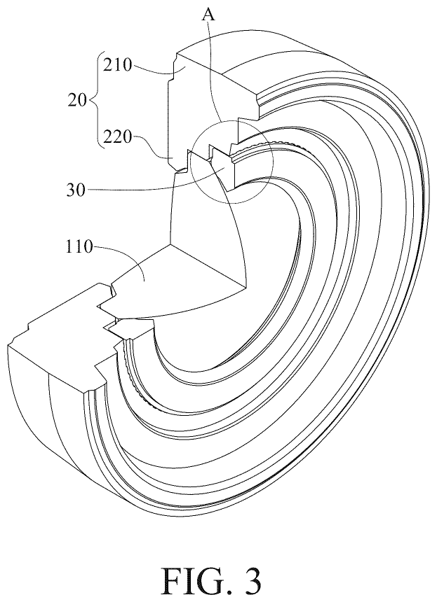

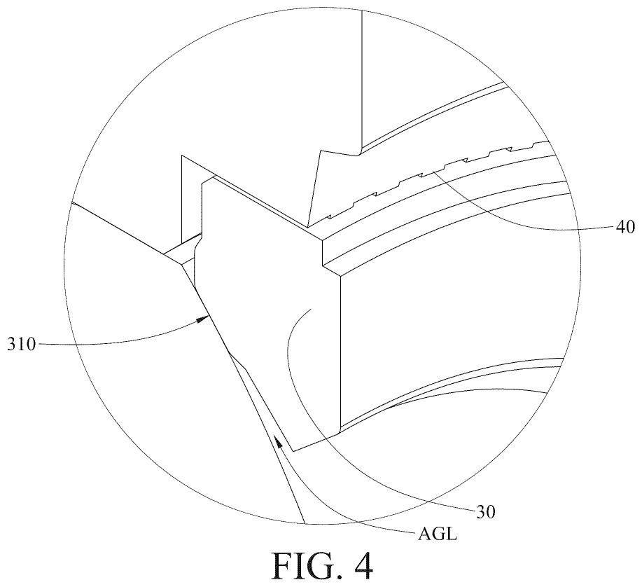

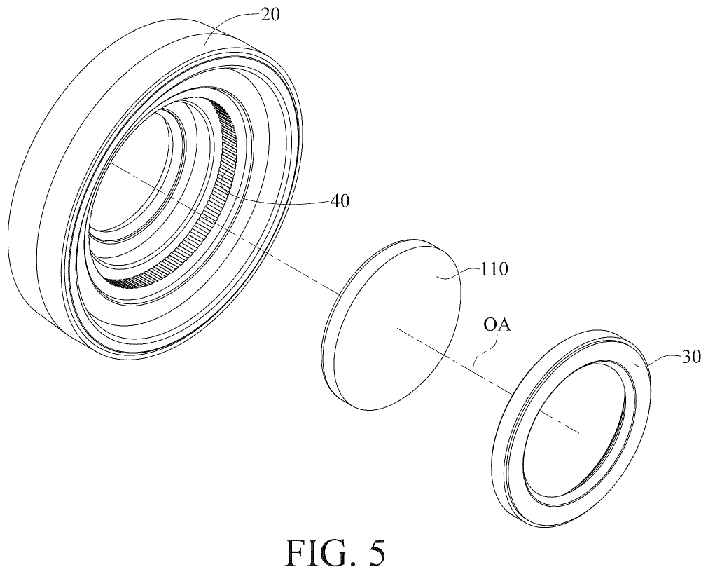

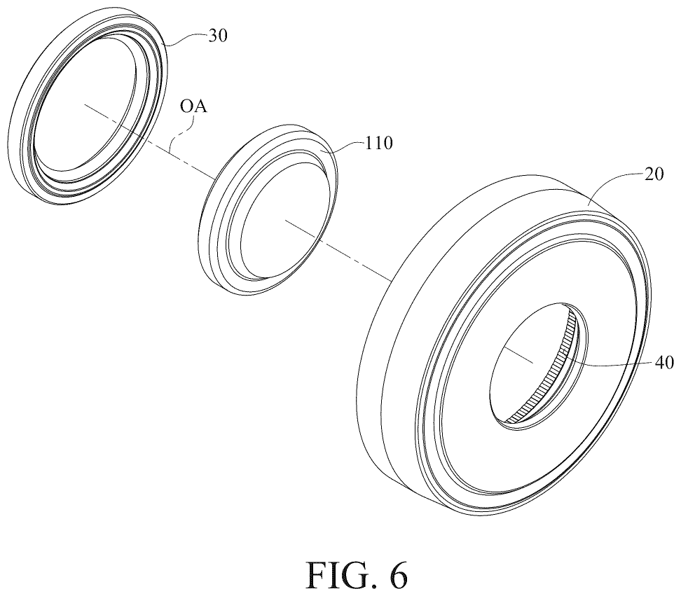

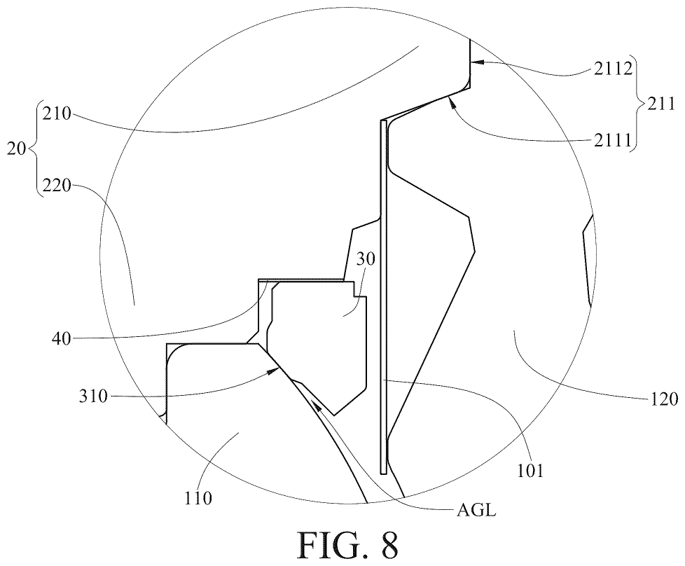

Please refer to FIG. 1 to FIG. 8, where FIG. 1 is a perspective view of an imaging lens system according to the 1st embodiment of the present disclosure, FIG. 2 is a partially sectioned view of the imaging lens system in FIG. 1, FIG. 3 is a partially sectioned view of some components of the imaging lens system in FIG. 1, FIG. 4 is an enlarged view of region A in FIG. 3, FIG. 5 is an exploded view of some components of the imaging lens system in FIG. 1, FIG. 6 is another exploded view of the some components of the imaging lens system in FIG. 1, FIG. 7 is a cross-sectional view of the imaging lens system in FIG. 1, and FIG. 8 is an enlarged view of region B in FIG. 7.

In this embodiment, the imaging lens system 1 includes an imaging lens assembly 10, a spacer element 20 and a retaining element 30. The imaging lens assembly 10 includes a first lens element 110, a second lens element 120, a third lens element 130 and an optical shutter 101 arranged along an optical axis OA thereof. The first lens element 110 is disposed between the second lens element 120 and the third lens element 130, and the optical shutter 101 is disposed between the first lens element 110 and the second lens element 120. The first lens element 110 has positive refractive power, and the first lens element 110 is a glass lens element. The second lens element 120 is a plastic lens element, and the third lens element 130 is a plastic lens element.

The spacer element 20 is one-piece formed by injection molding process and has at least two gate traces. The spacer element 20 is configured for positioning the first lens element 110 between the second lens element 120 and the third lens element 130, and the spacer element 20 is configured to maintain a distance between the first lens element 110 and the second lens element 120 and maintain a distance between the first lens element 110 and the third lens element 130. The spacer element 20 includes a connecting part 210 and a supporting part 220. The connecting part 210 and the second lens element 120 are connected to each other, and the connecting part 210 and the third lens element 130 are connected to each other. In addition, the second lens element 120 and the third lens element 130 are respectively connected to two different sides of the spacer element 20 in an abutting manner, and the two different sides are opposite to each other. The supporting part 220 is connected to the connecting part 210 and extends from the connecting part 210 towards the optical axis OA. Moreover, the first lens element 110 is disposed on the supporting part 220. In this embodiment, the spacer element 20 serves as a spacer for maintaining the distance between the second lens element 120 and the third lens element 130.

The connecting part 210 has an axial connection structure 211, and the axial connection structure 211 is connected to the second lens element 120. The axial connection structure 211 includes an annular inclined surface 2111 and an annular planar surface 2112. The annular inclined surface 2111 is configured to coaxially align the first lens element 110 with the second lens element 120, and the annular planar surface 2112 is configured to maintain the distance between the first lens element 110 and the second lens element 120. In this embodiment, the optical shutter 101 is closer to the optical axis OA than the axial connection structure 211 to the optical axis OA.

The retaining element 30 is disposed between the first lens element 110 and the second lens element 120. The retaining element 30 is configured to fix the first lens element 110 to the supporting part 220 of the spacer element 20, and the retaining element 30 is not in physical contact with the second lens element 120 and the third lens element 130. The retaining element 30 includes a retaining surface 310, and the retaining surface 310 and the first lens element 110 are abutted against each other. In addition, there is an air gap AGL between the retaining element 30 and the first lens element 110, and the air gap AGL is adjacent to the retaining surface 310. In this embodiment, the retaining surface 310 is a circular conical surface in physical contact with a curved surface of the first lens element 110, and they can be abutted against each other in a surface contact manner or in a linear contact manner.

There are a plurality of strip structures 40 disposed between the spacer element 20 and the retaining element 30, each of the strip structures 40 extends in a direction parallel to the optical axis OA, and the strip structures 40 are arranged around the optical axis OA. In this embodiment, the strip structures 40 are disposed on the spacer element 20, and the strip structures 40 are located between the spacer element 20 and the retaining element 30.

When an outer diameter of the first lens element 110 is D1, and an outer diameter of the second lens element 120 is D2, the following conditions are satisfied:

D1=3.1 mm; D2=6 mm; and D1/D2=0.517.

When the outer diameter of the first lens element 110 is D1, and an outer diameter of the third lens element 130 is D3, the following conditions are satisfied:

D1=3.1 mm; D3=5.8 mm; and D1/D3=0.534.

When the number of lens elements of the imaging lens assembly 10 is N, the following condition is satisfied: N=6.

When an outer diameter of the retaining element 30 is Φr, and the outer diameter of the second lens element 120 is D2, the following conditions are satisfied:

Φr=3.6 mm; D2=6 mm; and Φr/D2=0.600.

### 2nd Embodiment

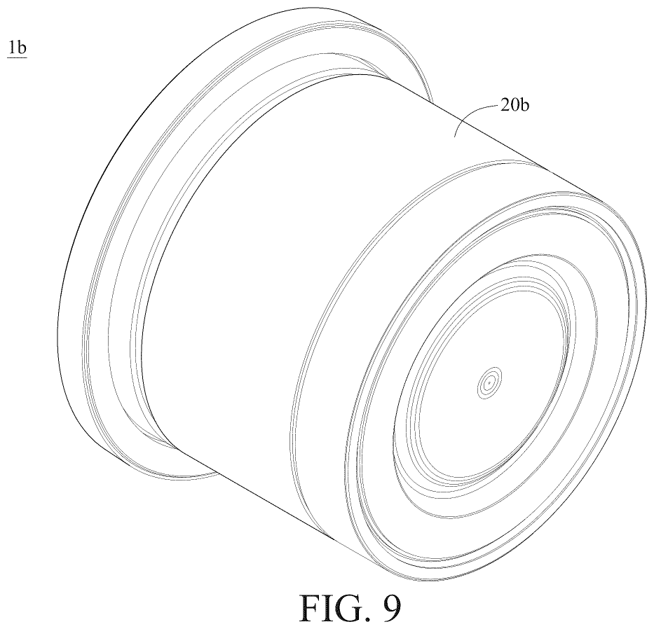

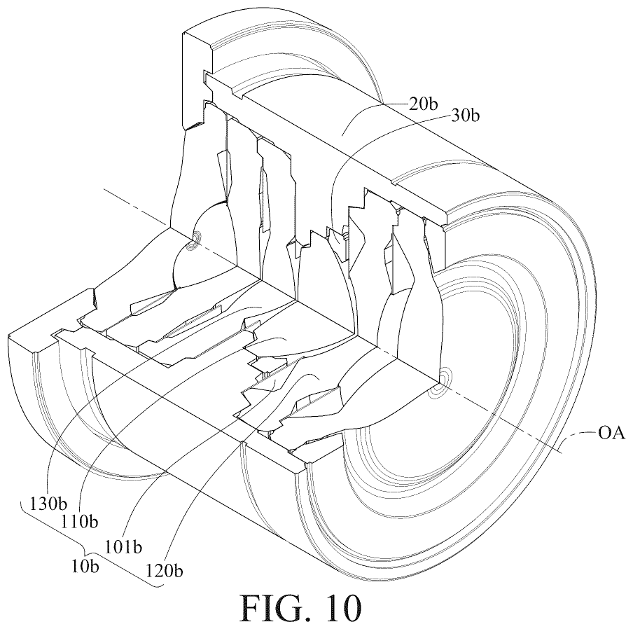

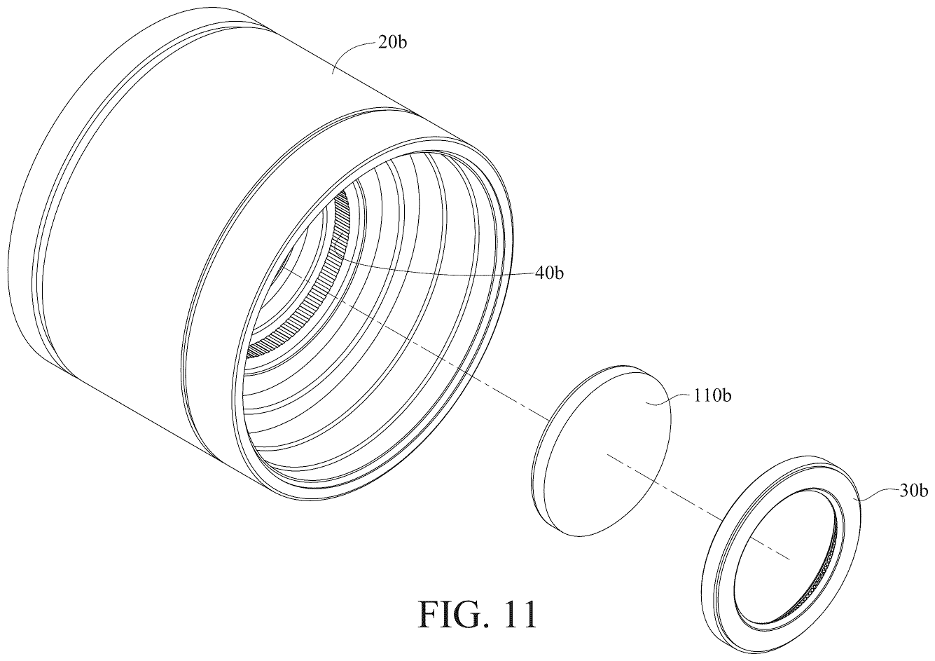

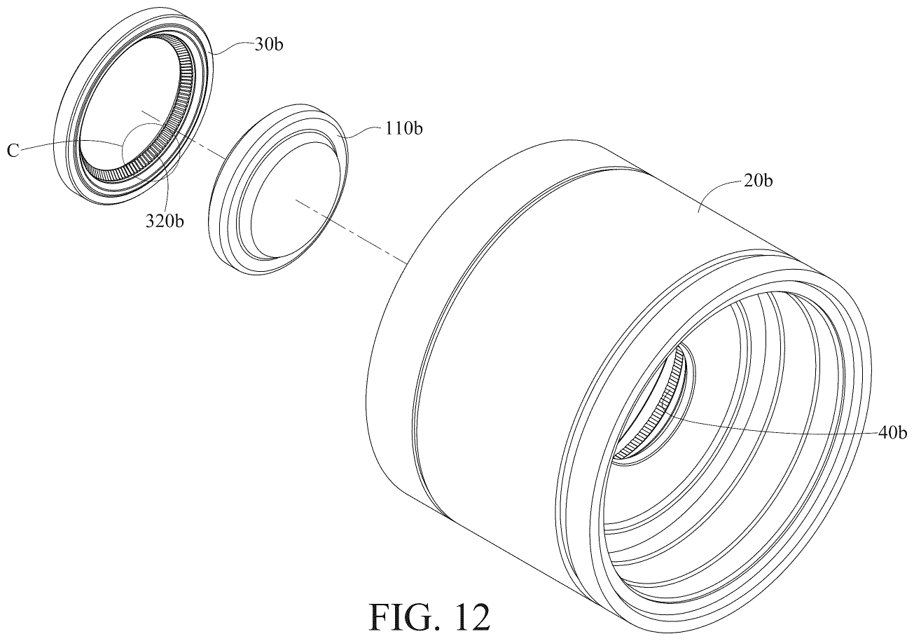

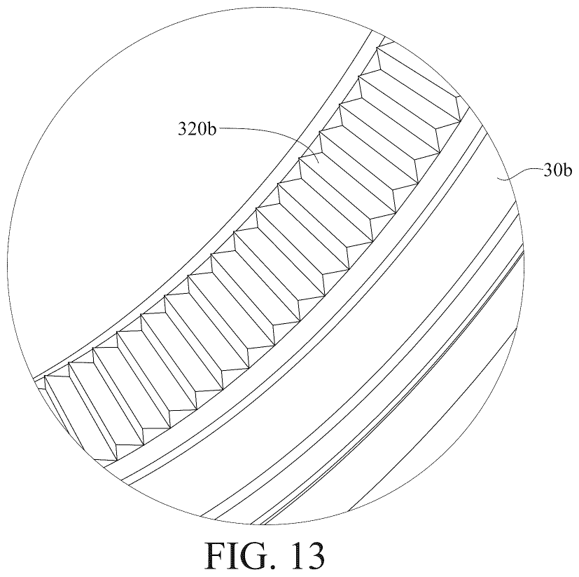

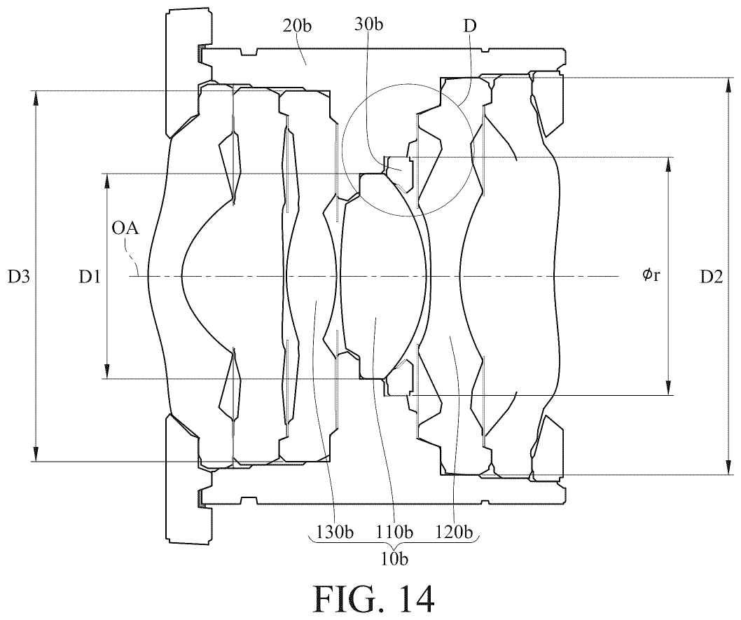

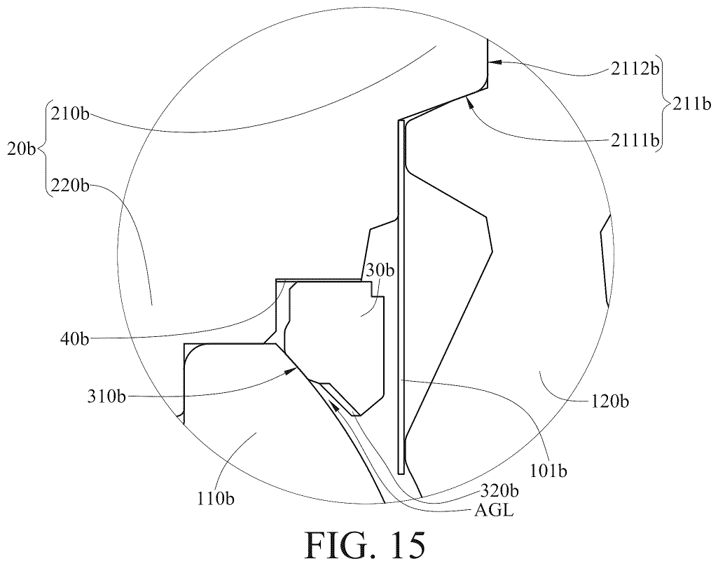

Please refer to FIG. 9 to FIG. 15, where FIG. 9 is a perspective view of an imaging lens system according to the 2nd embodiment of the present disclosure, FIG. 10 is a partially sectioned view of the imaging lens system in FIG. 9, FIG. 11 is an exploded view of some components of the imaging lens system in FIG. 9, FIG. 12 is another exploded view of the some components of the imaging lens system in FIG. 9, FIG. 13 is an enlarged view of region C in FIG. 12, FIG. 14 is a cross-sectional view of the imaging lens system in FIG. 9, and FIG. 15 is an enlarged view of region D in FIG. 14.

In this embodiment, an imaging lens system 1b includes an imaging lens assembly 10b, a spacer element 20b and a retaining element 30b.

The imaging lens assembly 10b includes a first lens element 110b, a second lens element 120b, a third lens element 130b and an optical shutter 101b arranged along an optical axis OA thereof. The first lens element 110b is disposed between the second lens element 120b and the third lens element 130b, and the optical shutter 101b is disposed between the first lens element 110b and the second lens element 120b. The first lens element 110b has positive refractive power, and the first lens element 110b is a glass lens element. The second lens element 120b is a plastic lens element, and the third lens element 130b is a plastic lens element.

The spacer element 20b is one-piece formed by injection molding process and has at least two gate traces. The spacer element 20b is configured for positioning the first lens element 110b between the second lens element 120b and the third lens element 130b, and the spacer element 20b is configured to maintain a distance between the first lens element 110b and the second lens element 120b and maintain a distance between the first lens element 110b and the third lens element 130b. The spacer element 20b includes a connecting part 210b and a supporting part 220b. The connecting part 210b and the second lens element 120b are connected to each other, and the connecting part 210b and the third lens element 130b are connected to each other. In addition, the second lens element 120b and the third lens element 130b are respectively connected to different sides of the spacer element 20b in an abutting manner. The supporting part 220b is connected to the connecting part 210b and extends from the connecting part 210b towards the optical axis OA. Moreover, the first lens element 110b is disposed on the supporting part 220b. In this embodiment, the spacer element 20b servers as a lens barrel and a spacer for accommodating the imaging lens assembly 10b and maintaining the distance between the second lens element 120b and the third lens element 130b.

The connecting part 210b has an axial connection structure 211b, and the axial connection structure 211b is connected to the second lens element 120b. The axial connection structure 211b includes an annular inclined surface 2111b and an annular planar surface 2112b. The annular inclined surface 2111b is configured to coaxially align the first lens element 110b with the second lens element 120b, and the annular planar surface 2112b is configured to maintain the distance between the first lens element 110b and the second lens element 120b. In this embodiment, the optical shutter 101b is closer to the optical axis OA than the axial connection structure 211b to the optical axis OA.

The retaining element 30b is disposed between the first lens element 110b and the second lens element 120b. The retaining element 30b is configured to fix the first lens element 110b to the supporting part 220b of the spacer element 20b, and the retaining element 30b is not in physical contact with the second lens element 120b and the third lens element 130b. The retaining element 30b includes a retaining surface 310b, and the retaining surface 310b and the first lens element 110b are abutted against each other. In addition, there is an air gap AGL between the retaining element 30b and the first lens element 110b, and the air gap AGL is adjacent to the retaining surface 310b. In this embodiment, the retaining surface 310b is a spherical surface, the retaining surface 310b is in physical contact with a curved surface of the first lens element 110b, and they can be abutted against each other in a surface contact manner or a linear contact manner.

In this embodiment, the retaining element 30b includes a plurality of wedged structures 320b, each of the wedged structures 320b tapers off towards the air gap AGL, and the wedged structures 320b are arranged around the optical axis OA.

There are a plurality of strip structures 40b disposed between the spacer element 20b and the retaining element 30b, each of the strip structures 40b extends in a direction parallel to the optical axis OA, and the strip structures 40b are arranged around the optical axis OA. In this embodiment, the strip structures 40b is disposed on the spacer element 20b, and the strip structures 40b are located between the spacer element 20b and the retaining element 30b.

When an outer diameter of the first lens element 110b is D1, and an outer diameter of the second lens element 120b is D2, the following conditions are satisfied: D1=3.1 mm; D2=6 mm; and D1/D2=0.517.

When the outer diameter of the first lens element 110b is D1, and an outer diameter of the third lens element 130b is D3, the following conditions are satisfied:

D1=3.1 mm; D3=5.6 mm; and D1/D3=0.554.

When the number of lens elements of the imaging lens assembly 10b is N, the following condition is satisfied: N=6.

When an outer diameter of the retaining element 30b is Φr, and the outer diameter of the second lens element 120b is D2, the following conditions are satisfied: Φr=3.6 mm; D2=6 mm; and Φr/D2=0.600.

### 3rd Embodiment

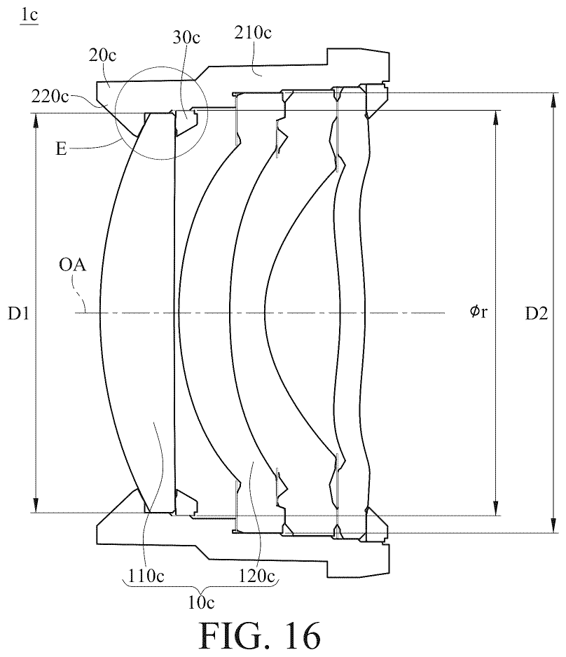

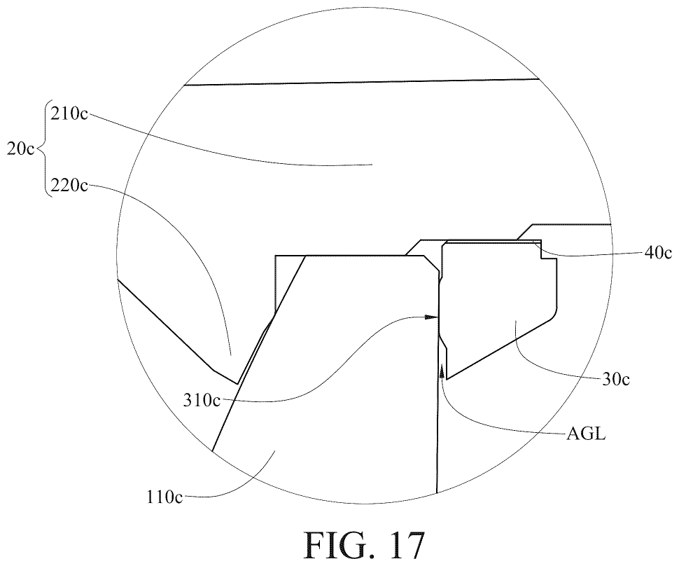

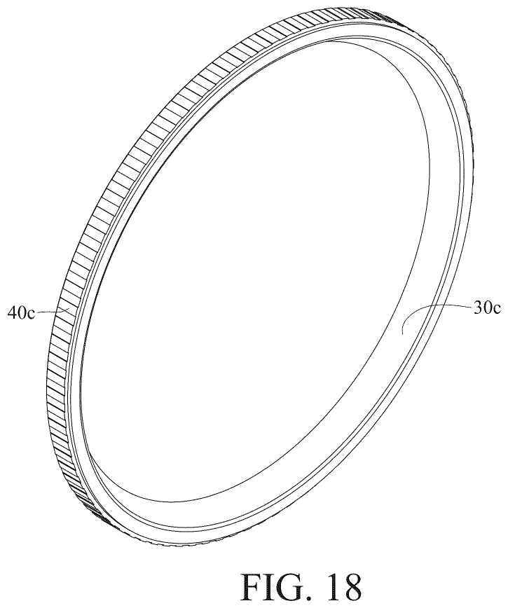

Please refer to FIG. 16 to FIG. 18, where FIG. 16 is a cross-sectional view of an imaging lens system according to the 3rd embodiment of the present disclosure, FIG. 17 is an enlarged view of region E in FIG. 16, and FIG. 18 is a perspective view of a retaining element in FIG. 16.

In this embodiment, an imaging lens system 1c includes an imaging lens assembly 10c, a spacer element 20c and a retaining element 30c.

The imaging lens assembly 10c includes a first lens element 110c and a second lens element 120c arranged along an optical axis OA thereof, and the first lens element 110c is adjacent to the second lens element 120c. The first lens element 110c has positive refractive power, and the first lens element 110c is a glass lens element. The second lens element 120c is a plastic lens element.

The spacer element 20c is one-piece formed by injection molding process and has at least two gate traces. The spacer element 20c is configured to maintain a distance between the first lens element 110c and the second lens element 120c. The spacer element 20c includes a connecting part 210c and a supporting part 220c. The connecting part 210c and the second lens element 120c are connected to each other, and the second lens element 120c and the spacer element 20c are connected to each other in an abutting manner. The supporting part 220c is connected to the connecting part 210c and extends from the connecting part 210c towards the optical axis OA. Moreover, the first lens element 110c is disposed on the supporting part 220c. In this embodiment, the spacer element 20c serves as a lens barrel for accommodating the imaging lens assembly 10c.

The retaining element 30c is disposed between the first lens element 110c and the second lens element 120c. The retaining element 30c is configured to fix the first lens element 110c to the supporting part 220c of the spacer element 20c, and the retaining element 30c is not in physical contact with the second lens element 120c. The retaining element 30c includes a retaining surface 310c, and the retaining surface 310c and the first lens element 110c are abutted against each other. In addition, there is an air gap AGL between the retaining element 30c and the first lens element 110c, and the air gap AGL is adjacent to the retaining surface 310c. In this embodiment, the retaining surface 310c is a spherical surface in physical contact with a curved surface of the first lens element 110c, and they can be abutted against each other in a surface contact manner or in a linear contact manner.

There are a plurality of strip structures 40c disposed between the spacer element 20c and the retaining element 30c, each of the strip structures 40c extends in a direction parallel to the optical axis OA, and the strip structures 40c are arranged around the optical axis OA. In this embodiment, the strip structures 40c is disposed on the retaining element 30c, and the strip structures 40c are located between the spacer element 20c and the retaining element 30c.

When an outer diameter of the first lens element 110c is D1, and an outer diameter of the second lens element 120c is D2, the following conditions are satisfied: D1=6.9 mm; D2=7.6 mm; and D1/D2=0.908.

When the number of lens elements of the imaging lens assembly 10c is N, the following condition is satisfied: N=4.

When an outer diameter of the retaining element 30c is Φr, and the outer diameter of the second lens element 120c is D2, the following conditions are satisfied: Φr=7 mm; D2=7.6 mm; and Φr/D2=0.921.

### 4th Embodiment

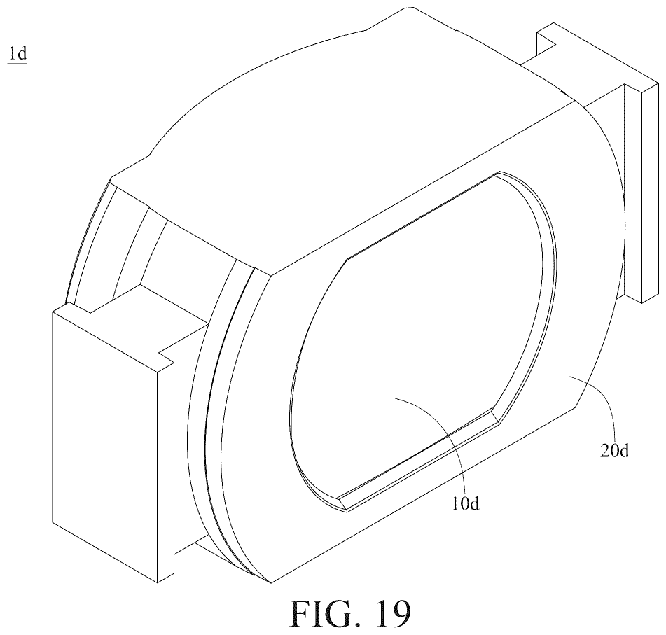

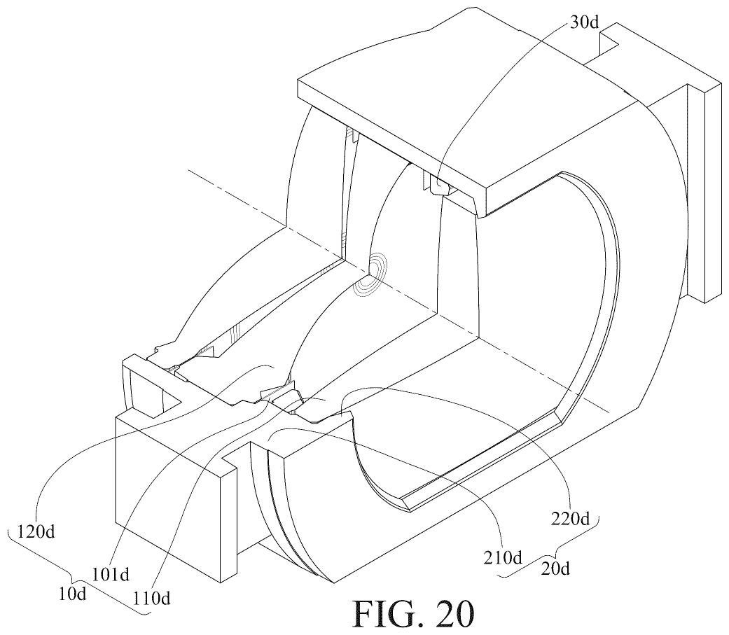

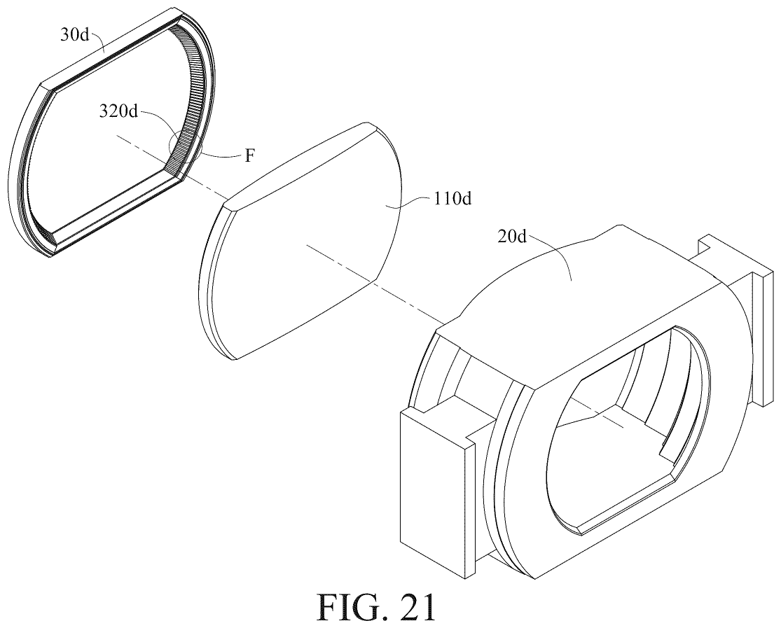

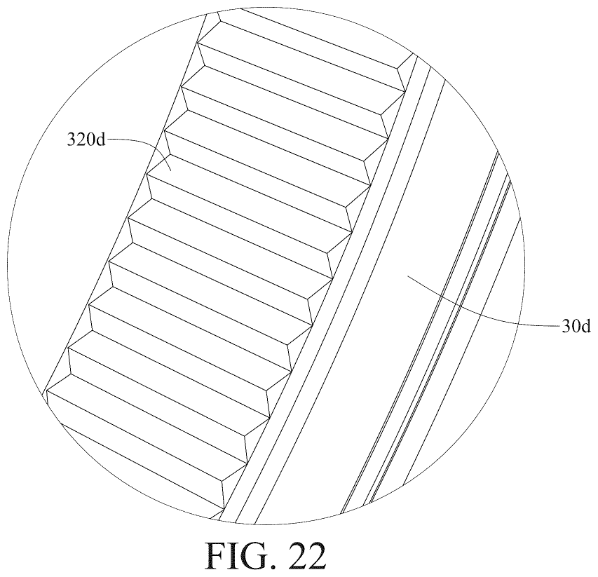

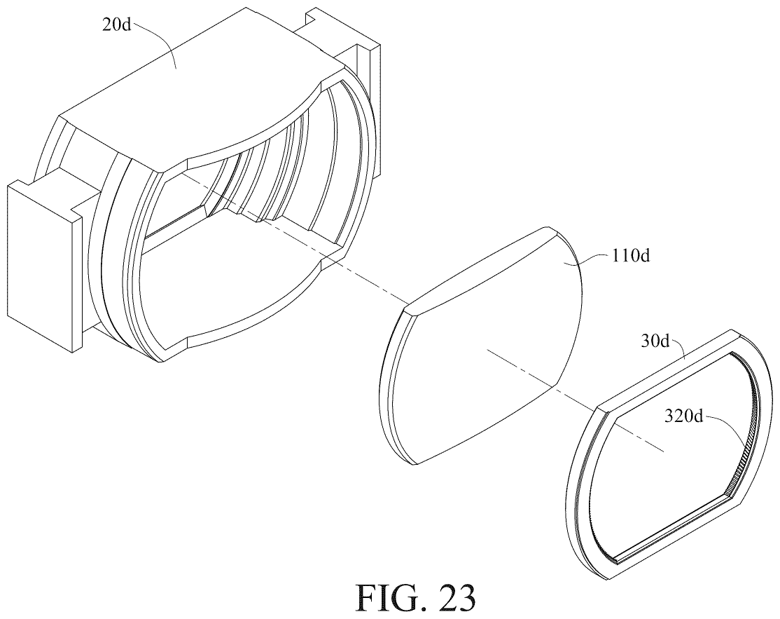

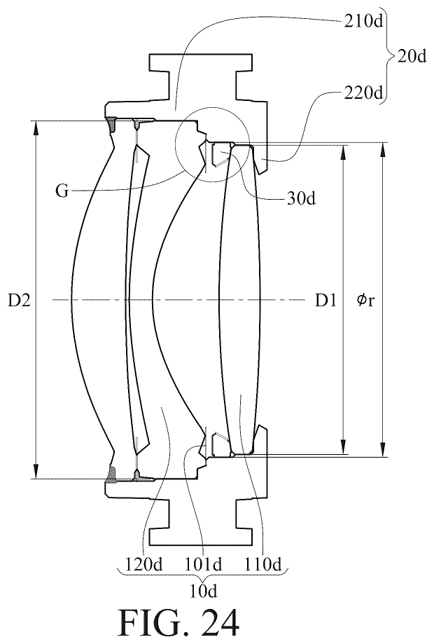

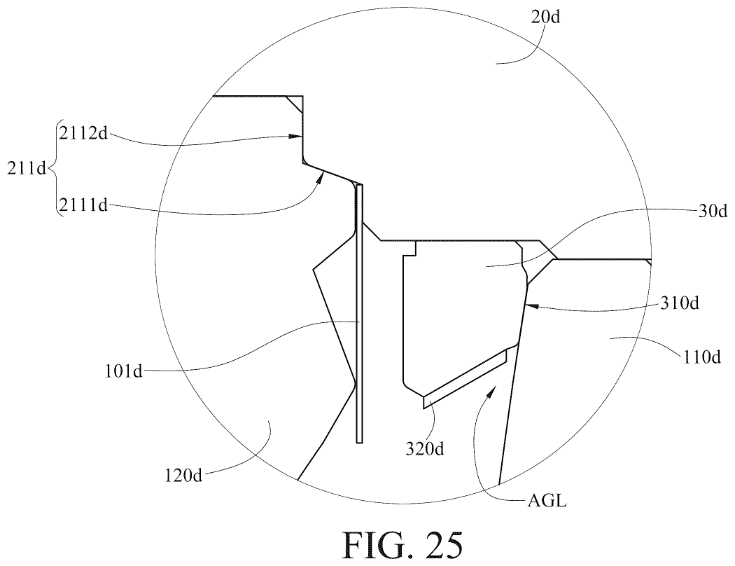

Please refer to FIG. 19 to FIG. 25, where FIG. 19 is a perspective view of an imaging lens system according to the 4th embodiment of the present disclosure, FIG. 20 is a partially sectioned view of the imaging lens system in FIG. 19, FIG. 21 is an exploded view of some components of the imaging lens system in FIG. 19, FIG. 22 is an enlarged view of region F in FIG. 21, FIG. 23 is another exploded view of the some components of the imaging lens system in FIG. 19, FIG. 24 is a cross-sectional view of the imaging lens system in FIG. 19, and FIG. 25 is an enlarged view of region G in FIG. 24.

In this embodiment, an imaging lens system 1d includes an imaging lens assembly 10d, a spacer element 20d and a retaining element 30d.

The imaging lens assembly 10d includes a first lens element 110d, a second lens element 120d and an optical shutter 101d arranged along an optical axis OA thereof. The first lens element 110d is adjacent to the second lens element 120d, and the optical shutter 101d is disposed between the first lens element 110d and the second lens element 120d. The first lens element 110d has positive refractive power, and the first lens element 110d is a glass lens element. The second lens element 120d is a plastic lens element.

The spacer element 20d is one-piece formed by injection molding process and has at least two gate traces. The spacer element 20d is configured to maintain a distance between the first lens element 110d and the second lens element 120d. The spacer element 20d includes a connecting part 210d and a supporting part 220d. The connecting part 210d and the second lens element 120d are connected to each other, and the second lens element 120d and the spacer element 20d are connected to each other in an abutting manner. The supporting part 220d is connected to the connecting part 210d and extends from the connecting part 210d towards the optical axis OA. Moreover, the first lens element 110d is disposed on the supporting part 220d. In this embodiment, the spacer element 20d serves as a lens barrel for accommodating the imaging lens assembly 10d.

The connecting part 210d has an axial connection structure 211d, and the axial connection structure 211d is connected to the second lens element 120d. The axial connection structure 211d includes an annular inclined surface 2111d and an annular planar surface 2112d. The annular inclined surface 2111d is configured to coaxially align the first lens element 110d with the second lens element 120d, and the annular planar surface 2112d is configured to maintain the distance between the first lens element 110d and the second lens element 120d. In this embodiment, the optical shutter 101d is closer to the optical axis OA than the axial connection structure 211d to the optical axis OA.

The retaining element 30d is disposed between the first lens element 110d and the second lens element 120d. The retaining element 30d is configured to fix the first lens element 110d to the supporting part 220d of the spacer element 20d, and the retaining element 30d is not in physical contact with the second lens element 120d. The retaining element 30d includes a retaining surface 310d, and the retaining surface 310d and the first lens element 110d are abutted against each other. In addition, there is an air gap AGL between the retaining element 30d and the first lens element 110d, and the air gap AGL is adjacent to the retaining surface 310d. In this embodiment, the retaining surface 310d is a spherical surface in physical contact with a curved surface of the first lens element 110d, and they can be abutted against each other in a surface contact manner or in a linear contact manner.

In this embodiment, the retaining element 30d includes a plurality of wedged structures 320d, each of the wedged structures 320d tapers off towards the air gap AGL, and the wedged structures 320d are arranged around the optical axis OA.

When an outer diameter of the first lens element 110d is D1, and an outer diameter of the second lens element 120d is D2, the following conditions are satisfied: D1=8.3 mm; D2=9.615 mm; and D1/D2=0.863.

When the number of lens elements of the imaging lens assembly 10d is N, the following condition is satisfied: N=3.

When an outer diameter of the retaining element 30d is Φr, and the outer diameter of the second lens element 120d is D2, the following conditions are satisfied: Φr=8.45 mm; D2=9.615 mm; and Φr/D2=0.879.

### 5th Embodiment

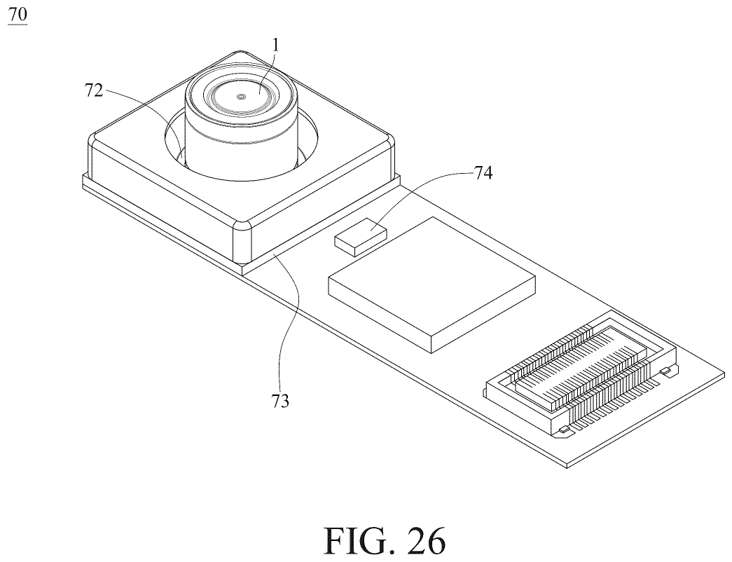

Please refer to FIG. 26, which is a perspective view of an image capturing unit according to the 5th embodiment of the present disclosure. In this embodiment, an image capturing unit 70 is a camera module including the imaging lens system 1 disclosed in the 1st embodiment, a driving device 72, an image sensor 73 and an image stabilizer 74. However, in other configurations, the image capturing unit 70 may include the imaging lens system in the 2nd embodiment, 3rd embodiment or 4th embodiment, and the present disclosure is not limited thereto. The imaging light converges in the imaging lens assembly 10 of the imaging lens system 1 to generate an image with the driving device 72 utilized for image focusing on an image surface of the imaging lens system 1 and the image sensor 73, and the generated image is then digitally transmitted to other electronic component for further processing.

The driving device 72 is favorable for obtaining a better imaging position of the imaging lens system 1, so that a clear and sharp image of the imaged object can be captured by the imaging lens system 1 in different object distances. In addition, the image capturing unit 70 can be provided with the image sensor 73 (for example, CMOS or CCD), which can feature high photosensitivity and low noise, disposed on the image surface of the imaging lens system 1 to provide higher image quality.

The image stabilizer 74, such as an accelerometer, a gyro sensor and a Hall Effect sensor, is configured to work with the driving device 72 to provide optical image stabilization (OIS). The driving device 72 working with the image stabilizer 74 is favorable for compensating for pan and tilt of the imaging lens system 1 to reduce blurring associated with motion during exposure. In some cases, the compensation can be provided by electronic image stabilization (EIS) with image processing software, thereby improving image quality while in motion or low-light conditions.

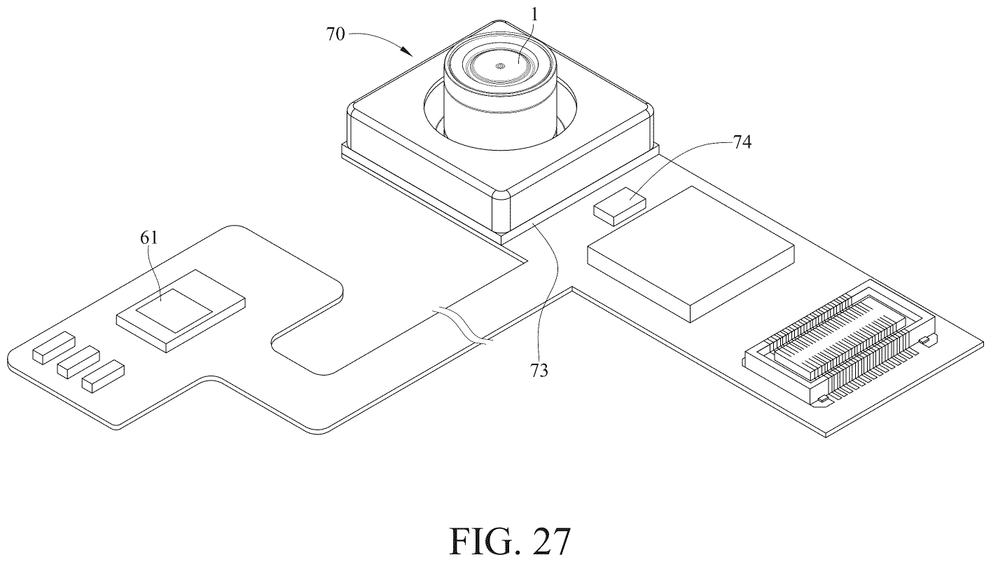

The present disclosure is not limited to the image capturing unit 70 in FIG. 26. FIG. 27 is a perspective view of another image capturing unit according to one embodiment of the present disclosure, wherein the image capturing unit 70 further includes a flash module 61, which can be activated for light supplement when capturing images to improve image quality.

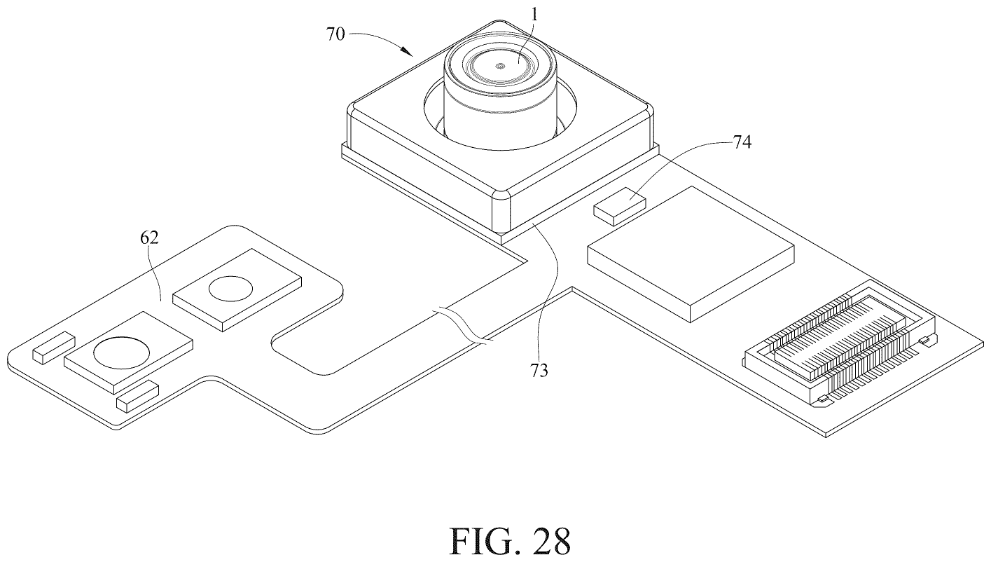

FIG. 28 is a perspective view of still another image capturing unit according to one embodiment of the present disclosure, wherein the image capturing unit 70 further includes a focus assist module 62 configured to detect an object distance to achieve fast auto focusing. The light beam emitted from the focus assist module 62 can be either conventional infrared or laser.

### 6th Embodiment

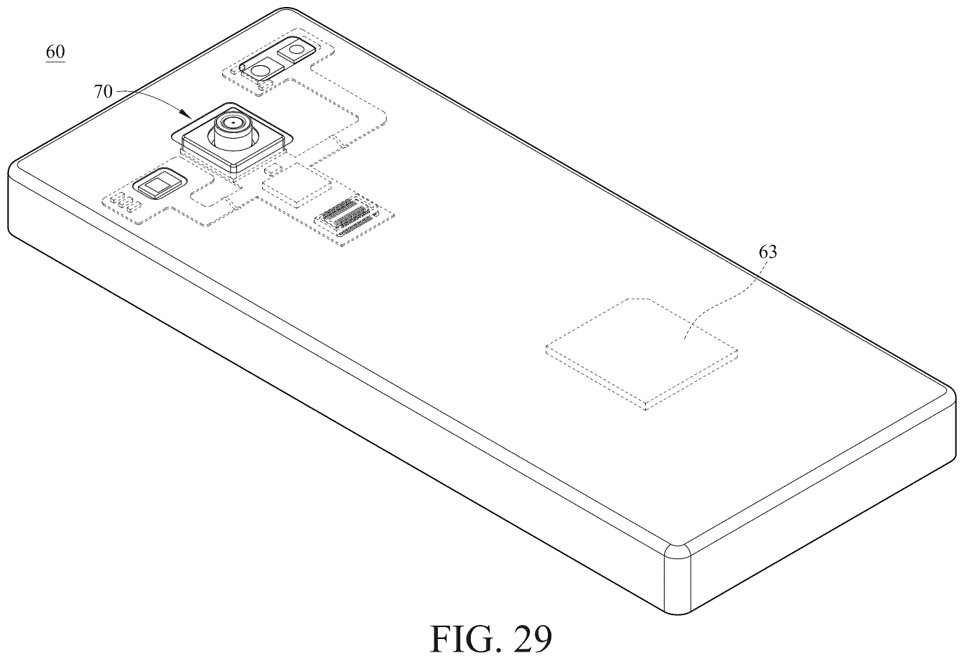

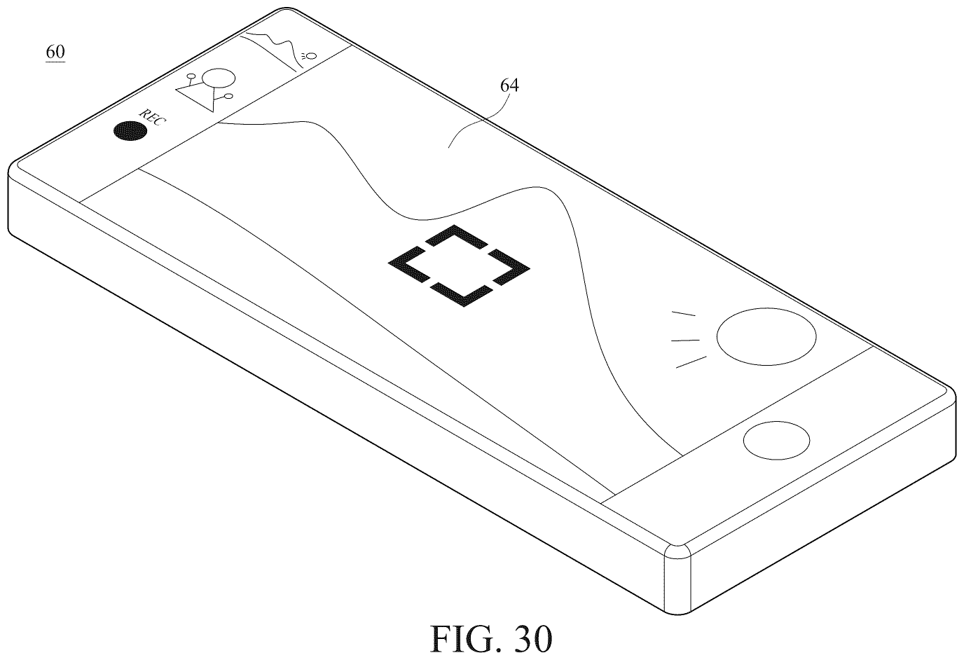

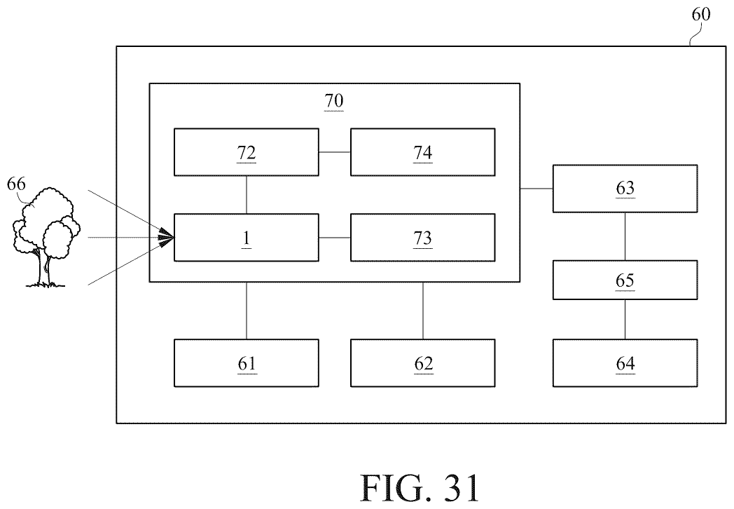

Please refer to FIG. 29 to FIG. 31, where FIG. 29 is one perspective view of an electronic device according to the 6th embodiment of the present disclosure, FIG. 30 is another perspective view of the electronic device in FIG. 29, and FIG. 31 is a block diagram of the electronic device in FIG. 29.

In this embodiment, an electronic device 60 is a smartphone including the image capturing unit 70 disclosed in the 5th embodiment, an image signal processor 63, a display unit (user interface) 64 and an image software processor 65. In this embodiment, the image capturing unit 70 includes the imaging lens system 1, the driving device 72, the image sensor 73, the image stabilizer 74, the flash module 61 and the focus assist module 62.

When a user captures images of an object 66, the light rays converge in the image capturing unit 70 to generate an image(s), and the flash module 61 is activated for light supplement. The focus assist module 62 detects the object distance of the imaged object 66 to achieve fast auto focusing. The image signal processor 63 is configured to optimize the captured image to improve image quality. The light beam emitted from the focus assist module 62 can be either conventional infrared or laser. The display unit 64 can be a touch screen or have a physical shutter button. The user is able to interact with the display unit 64 and the image software processor 65 having multiple functions to capture images and complete image processing. The image processed by the image software processor 65 can be displayed on the display unit 64.

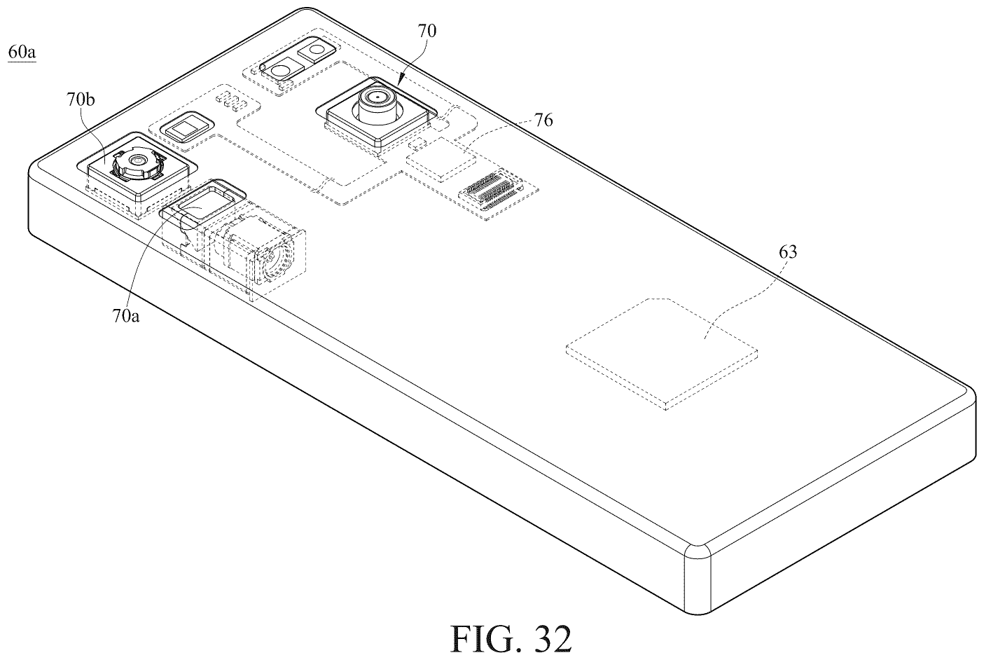

The electronic device of the present disclosure is not limited to the number of image capturing units as described above. FIG. 32 is a perspective view of another electronic device according to one embodiment of the present disclosure. An electronic device 60a is similar to the electronic device 60, and the electronic device 60a further includes an image capturing unit 70a and an image capturing unit 70b. The image capturing unit 70, the image capturing unit 70a and the image capturing unit 70b all face the same direction and each has a single focal point. In addition, the image capturing unit 70, the image capturing unit 70a and the image capturing unit 70b have different fields of view (e.g., the image capturing unit 70a is a telephoto image capturing unit, the image capturing unit 70b is a wide-angle image capturing unit, and the image capturing unit 70 has a field of view ranging between the image capturing unit 70a and the image capturing unit 70b), such that the electronic device 60a has various magnification ratios so as to meet the requirement of optical zoom functionality. Furthermore, in this embodiment, the image capturing unit 70 further includes an expansion image signal processor 76. When the image capturing unit 70 works with the telephoto image capturing unit 70a and wide-angle image capturing unit 70b, the expansion image signal processor 76 provides zoom functionality for images on the touch screen so as to meet image processing requirements for multiple image capturing units. The electronic device 60a equipped with the image capturing unit 70 has various modes of different photographing functions, such as zoom function, telephotography, multi-camera recording, selfie-optimized function, and high dynamic range (HDR) and 4K resolution imaging under low-light conditions.

The smartphone in this embodiment is only exemplary for showing the imaging lens system of the present disclosure installed in an electronic device, and the present disclosure is not limited thereto. The imaging lens system can be optionally applied to optical systems with a movable focus. Furthermore, the imaging lens system features good capability in aberration corrections and high image quality, and can be applied to 3D (three-dimensional) image capturing applications, in products such as digital cameras, mobile devices, digital tablets, smart televisions, network surveillance devices, dashboard cameras, vehicle backup cameras, multi-camera devices, image recognition systems, motion sensing input devices, wearable devices and other electronic imaging devices.

The foregoing description, for the purpose of explanation, has been described with reference to specific embodiments. It is to be noted that the present disclosure shows different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An imaging lens system, comprising:
an imaging lens assembly, comprising a first lens element, a second lens element and a third lens element, wherein the first lens element is a glass lens element, and the second lens element and the third lens element are plastic lens elements;
a spacer element, configured for positioning the first lens element between the second lens element and the third lens element and configured to maintain a distance between the first lens element and the second lens element and maintain another distance between the first lens element and the third lens element, and the spacer element comprising:
a connecting part, wherein the second lens element and the third lens element are respectively connected to opposite sides of the connecting part in a direction parallel to an optical axis of the imaging lens assembly; and
a supporting part, connected to the connecting part and extending from the connecting part towards the optical axis of the imaging lens assembly, wherein the first lens element is disposed on the supporting part; and
a retaining element, comprising a retaining surface, wherein the retaining surface and the first lens element are abutted against each other so as to fix the first lens element to the supporting part of the spacer element, and the retaining surface and the supporting part are respectively in physical contact with opposite surfaces of the first lens element;
wherein there is an air gap between the retaining element and the first lens element, and the air gap is adjacent to the retaining surface; and
wherein an outer diameter of the first lens element is D1, an outer diameter of the second lens element is D2, an outer diameter of the third lens element is D3, and the following conditions are satisfied:
$$D 1 / D 2 < 1 ; and \\ D 1 / D 3 < 1 .$$

2. The imaging lens system of claim 1, wherein the retaining surface is formed as a part of a spherical surface, and the retaining surface is in physical contact with a curved surface of the first lens element.

3. The imaging lens system of claim 1, wherein the retaining surface is formed as a part of a conical surface, and the retaining surface is in physical contact with a curved surface of the first lens element.

4. The imaging lens system of claim 1, wherein the retaining element comprises a plurality of wedged structures, each of the plurality of wedged structures tapers off towards the air gap, and the plurality of wedged structures are arranged around the optical axis.

5. The imaging lens system of claim 1, wherein there are a plurality of strip structures disposed between the spacer element and the retaining element, each of the plurality of strip structures extends in a direction parallel to the optical axis, and the plurality of strip structures are arranged around the optical axis.

6. The imaging lens system of claim 1, wherein the connecting part has an axial connection structure connected to the second lens element, and the axial connection structure comprises:
an annular inclined surface, configured to coaxially align the first lens element with the second lens element; and
an annular planar surface, configured to maintain the distance between the first lens element and the second lens element.

7. The imaging lens system of claim 6, wherein the imaging lens assembly further comprises an optical shutter disposed between the first lens element and the second lens element, and the optical shutter is closer to the optical axis than the axial connection structure.

8. The imaging lens system of claim 1, wherein an outer diameter of the retaining element is Φr, the outer diameter of the second lens element is D2, and the following condition is satisfied:
$$ϕr / D 2 < 1.$$

9. An imaging lens system, comprising:
an imaging lens assembly, comprising a first lens element, a second lens element and a third lens element, wherein the first lens element is a glass lens element, and the second lens element and the third lens element are plastic lens elements;
a spacer element, configured for positioning the first lens element between the second lens element and the third lens element and configured to maintain a distance between the first lens element and the second lens element and maintain another distance between the first lens element and the third lens element, and the spacer element comprising:
a connecting part, wherein the second lens element and the third lens element are respectively connected to opposite sides of the connecting part in a direction parallel to an optical axis of the imaging lens assembly; and
a supporting part, connected to the connecting part and extending from the connecting part towards the optical axis of the imaging lens assembly, wherein the first lens element is disposed on the supporting part; and
a retaining element, comprising a retaining surface, wherein the retaining surface and the first lens element are abutted against each other so as to fix the first lens element to the supporting part of the spacer element, and the retaining surface and the supporting part are respectively in physical contact with opposite surfaces of the first lens element;
wherein the retaining element is disposed between the first lens element and the second lens element, and the retaining element is not in physical contact with the second lens element; and
wherein an outer diameter of the first lens element is D1, an outer diameter of the second lens element is D2, an outer diameter of the third lens element is D3, and the following conditions are satisfied:
$$D 1 / D 2 < 1 ; and \\ D 1 / D 3 < 1 .$$

10. The imaging lens system of claim 9, wherein the connecting part has an axial connection structure connected to the second lens element, and the axial connection structure comprises:
an annular inclined surface, configured to coaxially align the first lens element with the second lens element; and
an annular planar surface, configured to maintain the distance between the first lens element and the second lens element.

11. The imaging lens system of claim 10, wherein the imaging lens assembly further comprises an optical shutter disposed between the first lens element and the second lens element, and the optical shutter is closer to the optical axis than the axial connection structure.

12. The imaging lens system of claim 9, wherein the spacer element is one-piece formed by injection molding process.

13. The imaging lens system of claim 9, wherein an outer diameter of the retaining element is Φr, the outer diameter of the second lens element is D2, and the following condition is satisfied:
$$ϕr / D 2 < 1.$$

14. An imaging lens system, comprising:
an imaging lens assembly, comprising a first lens element, a second lens element and a third lens element;
a spacer element, configured for positioning the first lens element between the second lens element and the third lens element and configured to maintain a distance between the first lens element and the second lens element and maintain another distance between the first lens element and the third lens element, and the spacer element comprising:
a connecting part, wherein the connecting part and the second lens element are connected to each other, and the connecting part and the third lens element are connected to each other; and
a supporting part, connected to the connecting part and extending from the connecting part towards an optical axis of the imaging lens assembly, wherein the first lens element is disposed on the supporting part; and
a retaining element, comprising a retaining surface, wherein the retaining surface and the first lens element are abutted against each other so as to fix the first lens element to the supporting part of the spacer element;
wherein an outer diameter of the first lens element is D1, an outer diameter of the second lens element is D2, an outer diameter of the third lens element is D3, and the following conditions are satisfied:
$$D 1 / D 2 < 1 ; and \\ D 1 / D 3 < 1 .$$

15. The imaging lens system of claim 14, wherein a number of lens elements of the imaging lens assembly is N, and the following condition is satisfied:
$$3 \leq N \leq 10 .$$

16. The imaging lens system of claim 15, wherein the first lens element has positive refractive power.

17. The imaging lens system of claim 14, wherein the spacer element is one-piece formed by injection molding process.

18. The imaging lens system of claim 14, wherein there is an air gap between the retaining element and the first lens element, and the air gap is adjacent to the retaining surface.

19. The imaging lens system of claim 14, wherein the retaining element is not in physical contact with the second lens element, and the retaining element is not in physical contact with the third lens element.

20. An electronic device, comprising:
the imaging lens system of claim 14; and
an image sensor, disposed on an image surface of the imaging lens system.
